(19) United States
(12) Patent Application Publication
(10) Pub. No.: US 2009/0117239 A1
(43) Pub. Date: May 7, 2009

(54) RETAINED LOOSE COFFEE CONTAINER AND METHOD

(75) Inventors: Arthur H. Bunn, Springfield, IL (US); James I. Miller, Decatur, IL (US)

Correspondence Address: BARNES & THORNBURG LLP, P.O. BOX 2786, CHICAGO, IL, 60690-2786, US

(73) Assignee: BUNN-O-MATIC CORPORATION, Springfield, IL (US)

(21) Appl. No.: 11/913,920

(22) PCT Filed: May 10, 2006
(86) PCT No.: PCT/IB06/51461

§ 371 Date: Sep. 10, 2008

Related U.S. Application Data
(60) Provisional application No. 60/679,790, filed on May 11, 2005.
(60) Provisional application No. 60/699,261, filed on Jul. 14, 2005.

(51) Int. Cl. A47J 31/06

(52) U.S. Cl. 426/433; 99/289 R; 426/431

(57) ABSTRACT

A reusable beverage container for use with a beverage maker to retain a beverage making substance therein. The reusable container has a container portion, a base and a cover. The base is coupled to the container portion and at least a portion of the base is foraminous. The cover is displaceably retained on the container for allowing a beverage making substance to be placed in the container and retained therein. At least a portion of the base is faraminous. The container may also be in the form of a kit for use with a beverage maker for containing a beverage making substance. The kit includes a cover displaceably retained on a holder of the beverage maker. The holder defines a cavity for retaining beverage making substance and the cover is displaceably positionable over the cavity for selectively retaining beverage substance in the holder.

### BACKGROUND

A variety of brewing apparatus have been developed to combine heated water with a brewing substance such as ground coffee or tea material in order to infuse the material and produce a brewed beverage. There are many ways to combine the water with the brewing substance.

One way of brewing a beverage is to encapsulate the brewing substance in a filter material. The brewing substance in the filter material provides a convenient package for handling a predetermined quantity of brewing substance. The filter material provides a package or container for the brewing substance. This package allows the brewing substance to be handled prior to brewing and after brewing without complication or mess.

Such brewing substances pre-packaged in filter material are referred to as “pods” or “sachets.” Brewing substances can be compressed while packaging in the filter material or left in a generally loose condition. Pods are typically circularly shaped and have a somewhat flattened configuration. Thus, pods often are provided in the shape of a disc or puck. Pods may be provided in a range in a sizes from approximately 45 mm to 60 mm and contain approximately 9-11 grams of brewing substance. The typical pod is used to produce approximately 8 ounces of brewed beverage. As a result, pods are generally used in conjunction with single-serve brewers (i.e., one or two cup brewers) rather than the larger, multi-serve brewers.

Although convenient, pod use in single-serve brewers may be less desirable in some cases. For example, because the pods are prepackaged by a pod manufacturer, the selection of brewing substances is limited to the pod manufacturer's selection. As a result, a consumer or user may not be able to use his/her favorite brewing substance when utilizing a prepackaged pod. Similarly, because the pods are prepackaged, varying the strength of the resultant beverage may be accomplished by increasing or decreasing the amount of brewing water delivered to the brewing substance or the pattern of delivering water to the brewing substance.

Uniform flavor extraction from the brewing material may be more difficult to achieve with a pod. Unlike open filter brewer designs which use a cone or “cup cake” filter, brewing substance in a pod is confined within the pod and generally is not free to agitate in the brewing liquid. Instead, the brewing liquid tends to pass directly from the top of the pod to the bottom of the pod, collecting solubles as it passes through. This vertical flow pattern through the pod may result in some areas of the brewing substance being over extracted and other areas being under extracted. Accordingly, the flavor of the resulting beverage may be affected due to the non-uniform extraction of solubles, particles, and other flavor characteristics from the particles of brewing substance.

Some brewing substance holders have included a spring-loaded or other clam shell device. Such a clam shell device for holding loose coffee may include two partial container portions which include filter material. The partial container portions are brought together to retain a quantity of brewing substance there between. Water is passed through one portion, through the brewing substance retained therein, and out through the other portion. In this regard, this device can be used to infuse a coffee beverage or other brewing substance. However, such clam shell devices may not satisfy all of the requirements for a viable device depending on the construction and design, such that it may require some effort to fill, brew and clean.

In some instances, access to prepackaged pods is limited due, in part, to their proprietary nature (i.e., certain prepackaged pods are suitable for use in a particular single-serving brewer) and associated limited distribution. For example, some brands of prepackaged pods associated with the more expensive single-serving brewers may only be purchased from high-end department stores or mail/Internet ordering.

It would be desirable to provide an apparatus and method for selective containment of the brewing substance used in a brewer. It would also be desirable to provide the ability to allow a user to select the brewing substance used in a brewer from a wide variety of brewing substances, and to provide the ability to selectively adjust the quantity of brewing substance used in a brewer.

### DESCRIPTION OF THE DRAWINGS

The organization and manner of the structure and function of the disclosure, together with the further objects and advantages thereof, may be understood by reference to the following description taken in connection with the accompanying drawings, and in which:

FIG. 1 is a perspective view of an embodiment of a brewer for use with a loose brewing substance container as set forth in the present disclosure.

FIG. 2 is a perspective view of the holder of the brewer.

FIG. 2A is a partial fragment any cross sectional view of a portion of a housing of the holder taken along line 2A-2A in FIG. 2.

FIG. 3 is a perspective view of the holder including the loose brewing substance container disclosed herein shown in the closed position.

FIG. 4 is a bottom perspective view of the holder including the loose brewing substance container.

FIG. 5 is a perspective view of the holder including the loose brewing substance container shown in an open position.

FIG. 6 is a rear elevational view of the holder with the loose brewing substance container shown in an open position.

FIG. 7 is a front elevational view of the loose brewing system container with the cover shown in the closed position.

FIG. 8 is a side elevational view of the loose brewing substance container shown in an open position.

FIG. 9 is a perspective view of the base of the loose brewing substance container.

FIG. 10 is a perspective view of the cover of the loose brewing substance container.

FIG. 11 is a side elevational view of the cover of the loose brewing substance container.

FIG. 12 is a perspective view of a holder including another embodiment of a loose brewing substance container shown in the closed position.

FIG. 13 is a perspective view of the holder and loose brewing substance container of FIG. 12 shown in an open position.

FIG. 14 is a side elevational view of the holder and loose brewing substance container in an open position.

FIG. 15 is an exploded perspective view of the loose brewing substance container of FIG. 12.

FIG. 16 is a bottom view of the cover of the loose brewing substance container.

FIG. 17 is a perspective view of the base of the loose brewing substance container.

FIG. 18 is a bottom view of the base of the loose brewing substance container.

FIG. 19 is a perspective view of a holder including a further embodiment of a loose brewing substance container shown in the closed position.

FIG. 20 is a perspective view of the holder including the loose brewing substance container of FIG. 19 shown in an open position.

FIG. 21 is a perspective view of the loose brewing substance container of FIG. 19 shown in the closed position.

FIG. 22 is a side elevational view of the loose brewing substance container shown in the closed position.

FIG. 23 is a perspective view of the loose brewing substance container shown in an open position.

FIG. 24 is a side elevational view of the loose brewing substance container shown in an open position.

FIG. 25 is a perspective view of the base of the loose brewing substance container.

FIG. 26 is a top plan view of the cover of the loose brewing substance container.

FIG. 27 is a bottom view of the cover of the loose brewing substance container.

### DETAILED DESCRIPTION

While the present disclosure may be susceptible to embodiment in different forms, there is shown in the drawings, and will be described herein in detail, one or more embodiments with the understanding that the present description is to be considered an exemplification of the principles of the disclosure and is not intended to be exhaustive or to limit the disclosure to the details of construction and the arrangements of components set forth in the following description or illustrated in the drawings.

In general, a contained loose brewing substance container for use in a brewer is disclosed. The container may be configured in one of many suitable configurations adapted to enable substantial containment of a brewing substance while at the same time, allowing brewing substance selection and accommodating varying amounts of the selected brewing substance. Although described for use in a single-serving single brewer, it is contemplated that the container described herein may also be utilized with other types of brewing devices, for example, with a multiple cup brewer, espresso brewer, or a French-press or plunger-type beverage maker.

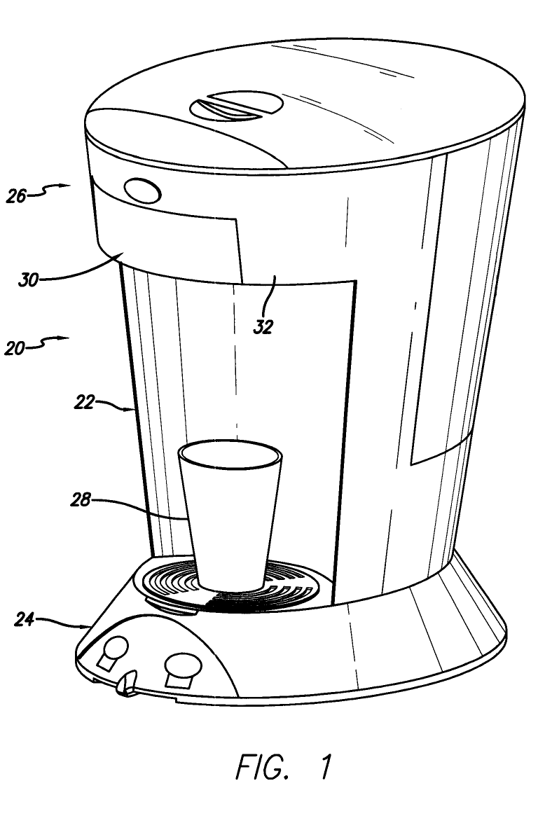

As shown in FIG. 1, a single-serving brewer 20 includes a body 22, a base 24 and an upper portion 26. The upper portion 26 is configured to be positioned above a container sun as a cup 28 for dispensing the brewed beverage into the cup 28. It should be noted that many different configurations of the single-serving brewers 20 can be utilized in conjunction with the various embodiments of the containers described in this disclosure. For example, in addition to the single-serve brewer manufactured by Bunn-O-Matic and described herein, single-serving brewers manufactured by Black & Decker, Krups, Home Café, Hamilton Beach, Mr. Coffee, Melitta, Senseo, Flavia, Keurig, and Nespresso, to name a few, can be utilized in conjunction with the containers.

Terms including beverage, beverage making and brewing as used herein are intended to be broadly defined as including but not limited to the brewing of coffee, tea, herbs, and any other brewed beverage. This broad interpretation is also intended to include, but is not limited to, any process of infusing, steeping, reconstituting, diluting, dissolving, saturating, or passing a liquid through or otherwise mixing or combining a beverage substance with a liquid such as water without a limitation to the temperature of such liquid unless specified. This broad interpretation is also intended to include, but is not limited to, beverage substances such as ground coffee, tea, herbs, liquid beverage concentrate, powdered beverage concentrate, freeze dried coffee, or other beverage concentrates, to obtain a desired beverage or other food.

As shown in FIG. 1, the upper portion 26 of the single-serving brewer 20, includes a holder 30 attached to a mounting portion 32 of the upper portion 26. The holder 30 has a drawer-like configuration to retain a volume of brewing substance, such as in a container 60 as disclosed in various embodiments herein, in a predetermined position. The specific embodiment of the brewer is provided for illustration. Use of the disclosed structures and methods with other brewers in addition to the specific embodiment shown is within the scope of the disclosure. While a holder 30 as described herein is shown as having a drawer-like configuration, it is contemplated that a variety of suitably configured holders may be used to retain the containers 60 described herein. For example, a variety of brewing devices as mentioned above might include a clam shell type of pod holder, as well as an espresso-type beverage holder. It is envisioned that the containers 60 of the present disclosure may be configured to accommodate these various brewing apparatus.

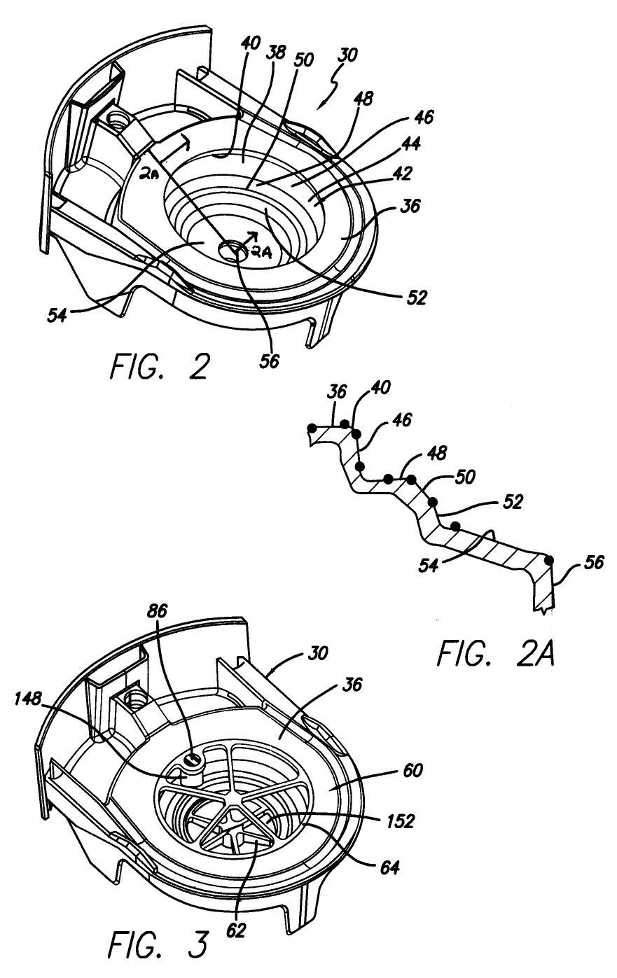

As shown in FIG. 2, the holder 30 includes a generally planar and horizontal top wall 36. The top wall 36 includes a generally circular opening 38 formed by a generally circular rim 40 in the top wall 36. With further reference to FIG. 2A, the edge of the top wall 36 adjacent the rim 40 may be sloped downwardly and inwardly forming a generally annular and conical-shaped surface. The holder 30 also includes a housing 42 attached to the top wall 36. The housing 42 includes an open top cavity 44 in fluid communication with the opening 38 of the to wall 36. The housing 42 includes a generally vertical and generally cylindrical side wall 46 that extends along and downwardly from the rim 40. A generally planar and generally horizontal annular shelf 48 extends inwardly from the bottom end of the side wall 46. An inclined generally conical-shaped wall 50 extends downwardly and inwardly from the inner end of the shelf 48 to a generally vertical and cylindrical wall 52. The wall 52 is connected a floor 54. The floor 54 includes a generally centrally located passageway 56 that extends generally vertically through the floor 54. The passageway 56 is in fluid communication with the cavity 44 and the opening 38 of the top wall 36. The configuration of the housing 42 may take various different forms and constructions as desired. A brewed beverage is adapted to be dispensed from the cavity 44 through the passageway 56 into the cup 28.

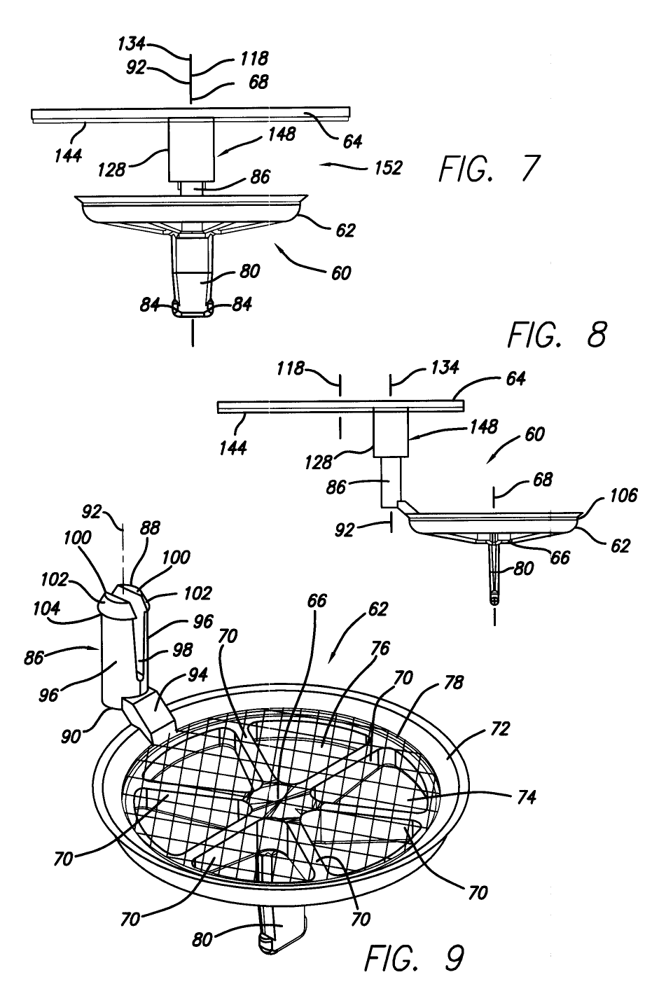

With reference to FIG. 3, a contained loose brewing substance container 60 is adapted to be located within the cavity 44 of the holder 30. The container 60 includes a base 62 and a cover 64 that is movably connected to the base 62. As shown in FIGS. 7-9, the base 62 includes a central hub 66 having a centrally located generally vertical axis 68. One or more arms 70 extend generally radially outwardly from the hub 66 and axis 68 to a generally circular rim 72. The arms 70 ear generally spaced equidistantly apart from one another about the axis 68. An opening 74 is formed between each adjacent pair of arms 70 and the portion of the rim 72 that extends between these arms. The arms 70 and hub 66 each include generally planar top surfaces which are all generally horizontal and generally coplanar with one another.

As shown in FIG. 9, a liquid permeable support member 76 is located on top of the top surfaces of the hub 66 and arms 70 and generally covers the area formed within an inner generally circular edge 78 of the rim 72. The support member 76 thereby covers all of the openings 74 that are located between the arms 70. Alternatively, the base 62 may include a plurality of support members 76, wherein each support member covers a respective opening 74 or more than one opening 74. The outer peripheral edge of the support member 76 may be permanently attached to the rim 72 by various means, such as for example, molding the edge of the support member 76 to or within the rim 72, by welding, or by adhesives. Alternatively, the support member 76 may be selectively removable from the hub 66, arm 70, and rim 72, and if desired may be removably connected to the rim 72 such as by the use of a snap-fit connection or other releasable connections as are well known. The support member 76 is not shown in FIG. 3 or 5 to provide an unobstructed view of the other elements of the base 62.

The liquid permeable support member 76 may be a foraminous member and may include a plurality of apertures or passageways. For example, the support member 76 may comprise a liquid permeable screen or mesh member that is formed from woven or non-woven material made of plastic, metal, or any other suitable material or combination of materials. The support member 76 may comprise a wire mesh screen or a foraminated plate, made of metal, plastic, or other suitable material. The support member 76 may be of any suitable construction having a suitable number of apertures of appropriate size to be compatible with the type of brewing substance used. While the terms screen and mesh have been used, it is contemplated that other suitable foraminous liquid permeable structures and materials may be used to allow water and brewed beverage to pass through the support member 76 while generally preventing portions of the brewing substance from passing through the support member 76.

The base 62 also includes a blade 80 that extends downwardly from the bottom side of the hub 66 to a bottom end 82. The blade 80 extends downwardly along the axis 68. The blade 80 is generally relatively thin and wide, including generally narrow sides as shown in FIG. 8 and generally wide front and back surfaces as shown in FIG. 7. The width of the blade 80 as shown in FIG. 7 is approximately equal to the diameter of the hub 66. The bottom end 82 of the blade 80 includes two outwardly extending cars 84. The ears 84 are adapted to provide a snap it releasable connection of the blade 80 to the passageway 56 of the holder 30, such that the container 60 is removably and replaceably releasably connected to the holder 30. It is expected and fully with in the scope of this disclosure that a variety of alternative embodiments could be implemented which achieve generally at least some of the blade, including retaining the base 62 proximate the holder.

The base 62 also includes an attachment member such as a generally vertical post 86 having a first end 88, a second end 90 and a generally vertical central axis 92. The axis 92 is spaced apart from and generally parallel to the axis 68. The second end 90 of the post 86 is located vertically above the rim 72 and is attached to the rim 72 by a bracket 94. As shown in FIG. 8, the post 86 is located horizontally outwardly beyond the rim 72. As shown in FIG. 9, the post 86 includes two upwardly extending legs 96 that are spaced apart from one another by an open-ended slot 98 that extends downwardly along the axis 92 from the first end 88 toward the second end 90 of the post 86. The outer surfaces of the legs 96 are generally formed as portions of a cylinder. Each leg 96 includes a tip 100 at the first end 88 that is formed as a portion of a truncated cone, such that each tip 100 includes a downwardly and outwardly inclined partial conical surface 102, and a partial circular lip 104 that projects radially outwardly beyond the cylindrical surface portion of the legs 96. The legs 96 are resilient such that they may be resiliently compressed wherein the respective tips 100 of the legs 96 are moved closer toward one another.

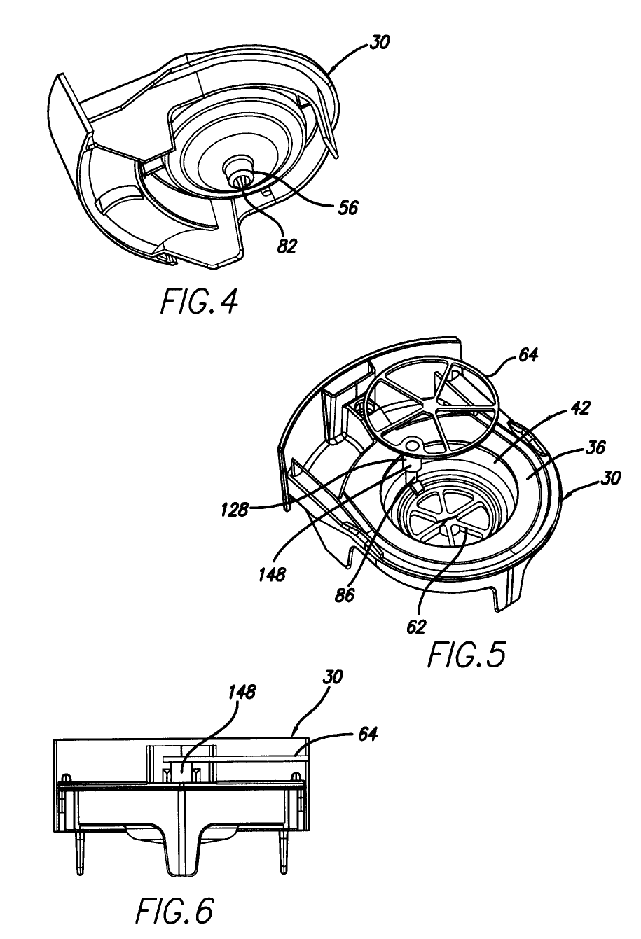

As shown in FIGS. 3-6, the base 62 of the container 60 is adapted to be located within the cavity 44 of the holder 30. The outer surface 106 of the rim 72 is configured and is adapted to matingly engage one or more walls, such as the inclined side wall 50, of the housing 42. The housing wall supports the hub 66, arms 70, and rim 72 above, and in spaced relation to, the floor 54 of the housing 42 to enable pooling and mixing of the brewed beverage in this space prior to dispensing through the passageway 56. The blade 80 extends downwardly through the passageway 56 of the housing 42 such that the bottom end 82 of the blade 80 projects outwardly from the passageway 56 as shown in FIG. 4. The blade 80 substantially divides the passageway 56 into two flow channels to provide columnar or laminar flow of the beverage as it is dispensed through the passage 56 into the cup 28. The post 86 is adapted to be located within the circumference of the side wall 46 of the housing 42 as shown in FIG. 5. While the base 62 is selectively removable from the housing 42 of the holder 30, the base may be permanently attached or integrally formed with the holder 30.

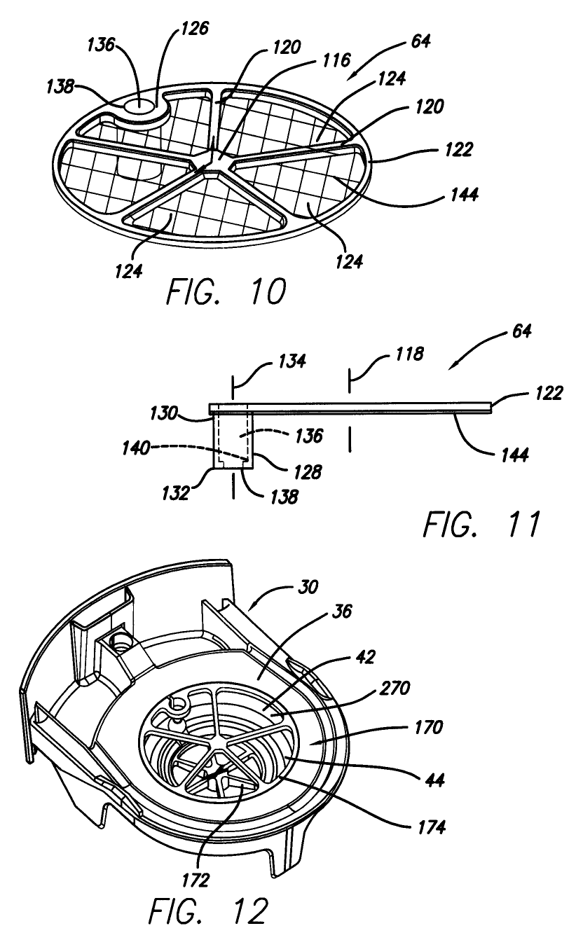

The cover 64 of the container 60 as shown in FIGS. 10-11, includes a central hub 116 having a central generally vertical axis 118. One or more arms 120 extend outwardly and generally radially from the hub 116 and axis 118 to a generally circular rim 122. The arms 120 are generally equally spaced about the axis 118. An opening 124 is formed between each adjacent pair of arms 120. A tab 126 extends inwardly into one of the openings 124 from the rim 122 and is generally located midway between two adjacent arms 120. Alternatively, the tab 126 may be located on an arm 120. An attachment member such as a collar 128 extends downwardly from the bottom side of the tab 126. The collar 128 includes a first end 130 that is attached to the tab 126 and a second end 132. The collar 128 includes a central generally vertical axis 134 that is generally parallel to and spaced a pair from the axis 118. The collar 128 includes a generally cylindrical outer surface and a generally cylindrical stepped bore 136 having a generally circular opening 138 at the second end 132. The tore 136 includes a generally annular ledge 140 located adjacent the second end 132. The bore 136 extends through the tab 126. The diameter of the bore 136 is greater at the first end 130 than it is at the second end 132. The bore 136 and opening 138 are adapted to receive the legs 96 of the post 86 of the base 62. If desired a gripping member may be attached to the top of the tab 126 to facilitate manual movement of the cover 64 with respect to the base 62.

The cover 164 includes a liquid permeable retainer member 144. The retainer member 144 is not shown in FIGS. 3 and 5 in order to more clearly show the other elements of the cover 64. The retainer member 144 may comprise a foraminous or otherwise liquid permeable material and may include a plurality of apertures or passageways and may be formed in the same manner and from the same materials as the support member 76. The retainer member 144 may be a mesh member or screen. If desired the liquid permeable material that forms the retainer member 144 may be different from the liquid permeable material that forms the support member 76 to achieve a desirable result. In this regard, it may be desirable to provide a larger number of apertures per a given area and/or larger apertures in the retainer member 144 than in the support member 76 to allow water to easily flow through the retainer member 144 while the smaller or finer apertures in the support member 76 may trap particles and other materials which may not be desirable for dispensing as part of a brewed substance into a cup 28 or consumption.

The retainer member 144 is located adjacent the bottom side of the hub 116, arms 120, and rim 122 and covers all of the openings 124. The retainer member 144 covers the entire area formed within the rim 122. Alternatively, a plurality of retainer members may be used, with each retainer member covering a respective opening 124 or plurality of openings 124. The retainer member 144 may be permanently attached to the rim 122 such as by molding the outer peripheral edge of the retainer member 144 to or within the rim 122, or by other means such as welding, or adhesives. Alternatively, the retainer member 144 may be removably attached to the rim 122 such as with a snap-fit connection or other releasable connections as are well known.

The cover 64 is removably connected to the base 62 by inserting the tips 100 of the legs 96 of the base 62 through the opening 138 and into the bore 136 of the collar 128 of the cover 64. The tips 100 of the legs 96 will move inwardly closer to one another as the conical tips 100 pass through the opening 138 and will resiliently move away from one another once the partial circular lips 104 of the tips 100 pass by the ledge 140. The post 86 and collar 128 comprise a connector mechanism 148 that movably and adjustably connects the cover 64 to the base 62. The connector mechanism 148 allows the cover 64 to be selectively moved with respect to the base 62 in a linear translational direction generally vertically and parallel to the axis 134, to selectively pivot rotationally about the axis 134 in a clockwise or counter-clockwise direction, and to move with a combination of such pivotal and translational movements. When the legs 96 are inserted within the bore 136 of the collar 128, the outer surfaces of the legs may be resiliently biased in engagement with the collar 128 such that the frictional force between the legs 96 and collar 128 will retain the cover 64 in whatever position it is moved to with respect to the base 62. The tips 100 of the legs 96 are adapted to engage the ledge 140 to prevent inadvertent disengagement of the cover 64 from the base 62 when the cover 64 is moved. The upper large diameter portion of the bore 136 may include a first detent, such as a generally circular groove, that is adapted to releasably retain the lips 104 of the legs 96 to releasably retain the cover 64 at a selected first vertically spaced distance from the base 62, such as in an open position, while allowing the cover 64 to be selectively rotatable about the axis 134. The upper large diameter portion of the bore 136 may include a second detent that is adapted to releasably retain the lips 104 of the legs 96 and thereby releasably inhibit rotation of the cover 64 about the axis 134 when the cover is in the open position. The upper large diameter portion of the bore 136 may also include a third detent, such as a generally circular groove, that is adapted to releasably retain the lips 104 of the legs 96 and thereby releasably retain the cover 64 at a selected second vertically spaced distance from the base 62, such as in the closed position.

As shown in FIG. 3, the cover 64 is in a closed operational position with respect to the base 62. In the closed position the legs 96 of the post 86 are retracted within the bore 136 of the collar 128 and the axis 118 of the cover 64 is substantially coaxially aligned with the axis 68 of the base 62. When the container 60 is located within the cavity 44 of the housing 42, the base 62 is engaged with and supported by one or more walls of the housing 42. The rim 122 of the cover 64 fits closely within the side wall 46 of the housing 42. The top surfaces of the hub 116, arms 120 and rim 122 of the cover 64 are substantially coplanar with the top surface of the top wall 36, or are located slightly there below. The cover 64 will thereby not present an obstruction to the insertion or removal of the holder 30 and container 60 from the mounting portion 32 of the brewer 20. When the cover 64 is in the closed operational position, a chamber 152 is formed between the support member 76 of the base 62, the retainer member 144 of the cover 64, and the housing 42. The chamber 152 is adapted to receive and retain a loose brewing substance, or if desired a pod.

As shown in FIGS. 5, 6, and 8, the cover 64 is located in an open position with respect to the base 62. The cover 64 may be located in any one of various open positions with respect to the base 62, wherein the cover 64 has been moved a selected translational distance away from the base 62 along the axis 92 and if desired rotated about the axis 92 with respect to the base 62 to a selected position in either a clockwise or counter-clockwise direction about the axis 92.

As shown in FIG. 5, the cover 64 is in an open position with respect to the base 62. As can be seen in this drawing figure a large amount of access is thereby provided to the base 62 and the portion of the cavity 44 of the housing 42 located above the base 62. A user may thereby easily add without obstruction a desired amount of a selected brewing substance onto the support member 76 of the base 62. The cover 64 may then be moved to the closed position wherein the brewing substance is contained within the chamber 152.

The openings 74 and 124 may be devised or otherwise shaped in a variety of configurations and geometries to produce various effects on the brewing process and achieve various results. The base 62 and cover 64 may be made of various different materials as desired, including plastic and metal.

In operation, a user will remove the holder 30, which includes the container 60 in its closed position, from the mounting member 32 of the brewer 20. The cover 64 is then moved generally linearly along the axis 92 with respect to the base 62 until the cover 64 is located a desired distance outside of the cavity 44 formed by the housing 42 and is located above the top wall 36. Thereafter the cover 64 may be selectively pivoted about the axis 92. The cover 64 may be raised with respect to the base 62 along the axis 92, and may be pivoted about the axis 92 with respect to the base 62, to ca extent as desired by the user to an open position. When the cover 64 is in the open position, the user may place a desired amount of selected brewing substance on the support member 76 of the base 62. The cover 64 is then returned to the closed position wherein brewing substance is retained within the chamber 152 between the base 62 and cover 64. The holder 30 is then replaced in the mounting member 32 of the brewer 20 for brewing a beverage. During the brewing process water flows through the retainer member 144 and openings 124 of the cover 64 and flows into the brewing substance within the chamber 152. The brewing substance is infused by the water and a beverage flows through the support member 76 and openings 74 of the base 62. Beverage flowing through the base 62 flows through the passageway 56 for dispensing into the cup 28.

After the completion of a beverage brewing cycle, the user removes the holder 30 from the mounting member 32 of the brewer 20. The cover 64 is then raised with respect to the base 62 until the circular lips 104 of the legs 96 of the post 86 engage the ledge 140 of the collar 128. The moist brewing substance retained on the support member 76 of the base 62 can then be dislodged for disposal. The container 60, including the base 62 and cover 64, may be easily rinsed and cleaned manually or in a dishwashing machine. Alternatively, if desired, the entire container 60 may be removed from the older 30 for disposal of the brewing substances and subsequent rinsing and cleaning. If desired the cover 64 can be removed from the base 62 for cleaning by pressing the legs 96 of the post 86 together such that the tips 100 will pass through the opening 138 in the collar 128 of the cover 64. The container 60 may be replaced in the cavity 44 of the holder 30 for subsequent use.

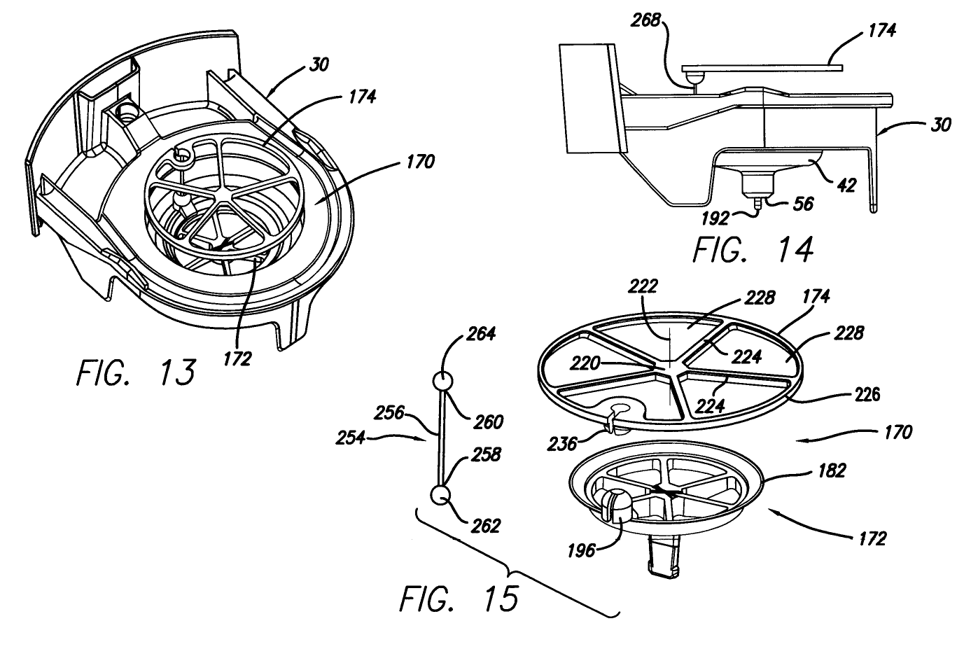

Another embodiment of the contained loose brewing substance container that is adapted for use in connection with the holder 30 is shown in FIGS. 12-18 and is identified with the reference number 170. The container 170 includes a base 172 and a cover 174 that is movably connected to the base 172. The cover 174 is selectively movable with respect to the base 172 between a closed operational position and an open position. As shown in FIG. 12, the container 170 is positioned within the cavity 44 of the housing 42 with the cover 174 located in the closed operational position. As shown in FIGS. 13-14, the base 172 of the container 170 is located within the cavity 44 of the housing 42 of the holder 30 and the cover 174 is located outside of the cavity 44 in an open position.

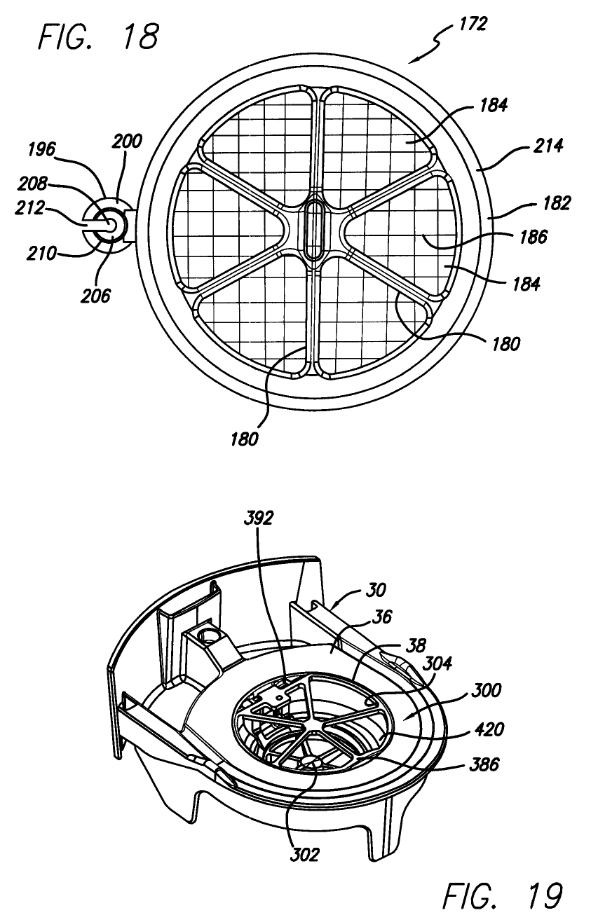

As shown in FIGS. 17-18, the base 172 includes a generally central hub 176 having a central generally vertical axis 178. One or more arms 180 extend generally radially outwardly from the hub 176 and axis 178 to a generally circular rim 182. An opening 184 is located between each adjacent pair of arms 180. As shown in FIG. 18 a liquid permeable support member 186 is located on the top of the hub 176 and arms 180 that extends within an area formed by man inner edge 188 of the rim 182. The support member 186 is not shown in FIG. 12, 13, 15, or 17 to provide a clear view of the remaining elements of the base 172. The support member 186 covers all of the openings 184. If desired a plurality of support members may be used with each support member covering a respective opening 184 or a plurality of openings. The support member 186 may be formed from a foraminous material and may include a plurality of apertures or passageways and may be constructed in various different manners and with different materials, including the same manners and materials in which the support member 76 is constructed. The base 172 also includes a blade 190 having a bottom end 192. The hub 176, arms 180, rim 182, support member 186, and blade 190 may be constructed substantially identical to the corresponding components of the base 62.

The base 172 includes an attachment member 196 such as a socket member. The attachment member 196 includes an upper first end 198, a lower second end 200, and a central generally vertical axis 202 that is spaced apart from and generally parallel to the axis 178. The attachment member 196 is connected to the rim 182 with a bracket 204. The attachment member 196 includes a hollow generally spherical chamber 206, an aperture 208 in the first end 198 that it is in communication with the chamber 206, and aperture 210 in the second end 200 that is in communication with the chamber 206. A generally vertical slot 212 extends through the side wall of the attachment member 196 from the aperture 208 to the aperture 210 such that the slot 212 is in communication with the apertures 208 and 210 and the chamber 206. The diameter of the aperture 210 is slightly smaller than the diameter of the generally spherical chamber 206. The diameter of the aperture 208 is smaller than the diameter of the aperture 210. As shown in FIG. 17, the attachment member 196 is located horizontally outwardly beyond the rim 182. The outer surface 214 of the rim 182 is adapted to matingly engage and be supported by one or more walls of the housing 42 in the same manner as the base 62. The blade 190 is adapted to extend through the passageway 56 as shown in FIG. 14. While the base 172 is selectively removable from the housing 42 of the holder 30, the base 172 may be permanently attached to and/or integrally formed with the holder 30.

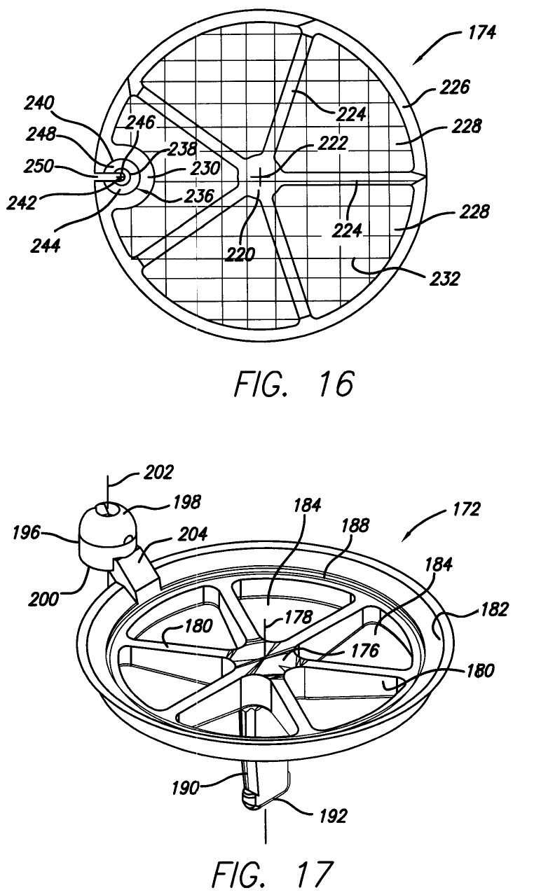

As shown in FIGS. 15 and 16, the cover 174 includes a central hub 220 having a central generally vertical axis 222. One or more arms 224 extend generally radially outwardly from the hub 220 to a generally circular rim 226. An opening 228 is located between each adjacent pair of arms 224. A tab 230 extends inwardly into an opening 228 from the rim 226. A gripping member may be located on the top of the hub 220 or the tab 230. A liquid permeable retainer member 232 is located adjacent the bottom surfaces of the hub 220 and arms 224. The retainer member 232 covers all of the opening 228 from the rim 226. A gripping member may be located on the top of the hub of retainer members 232 may be used, with each retainer member respectively covering one or more openings 228. The retainer member 232 is a foraminous member and may include a plurality of apertures or passageways and may be constructed from the same materials and in the same manners as the retainer member 144 is constructed. The retainer member 232 is not shown in FIGS. 12, 13, and 15 to provide a clear view of other elements of the cover 174 and base 172. The hub 220, arms 224, rim 226, and retainer member 232 of the cover 174 are constructed substantially identical to the corresponding components of the cover 64.

The cover 174 includes an attachment member 236, such as a socket, having a first end 238 and a second end 240. The second end 240 is attached to the bottom of the tab 230. The attachment member 236 includes a generally vertical central axis 242. The attachment member 236 includes a generally spherical chamber 244 having a generally circular aperture 246 at the first end 238 that is in communication with the chamber 244, and an aperture 248 at the second end 240 that is in communication with the chamber 244. A slot 250 extends through the side wall of the attachment member 236 and is in communication with the chamber 244 and apertures 246 and 248. The slot 250 also extends through a portion of the rim 226. The attachment member 236 is constructed substantially identical to the attachment member 196.

As shown in FIG. 15, the container 170 includes a connector member 254. The connector member 254 includes a tether 256 having a first end 258 and a second end 260. An engagement member 262 is attached to the first end 258 of the tether 256 and an engagement member 264 is attached to the second 260 of the tether 256. The tether 256 may be flexible and if desired may be resiliently elastic. The tether 256 may be formed as a string, cord, line, or strip of material and may be formed from various materials such as plastic. The tether 256 may also be formed as a chain including a plurality of links. The engagement members 262 and 264 are identical to one another and are formed as generally spherical members.

The engagement member 262 is adapted to be inserted and retained within the chamber 206 of the attachment member 196 of the base 172. The engagement member 262 has a diameter approximately equal to or slightly smaller than the diameter of the spherical chamber 206. The engagement member 262 has a diameter that is slightly larger than the diameter of the aperture 210 of the attachment member 196. The first end 258 of the tether 256 is attached to the base 172 by inserting a portion of the tether 256 into the slot 212 such that the tether 256 extends through the apertures 208 and 210. The engagement member 262 is then pressed through the aperture 210 into the chamber 206. The engagement member 262 is thereby snap fit into the chamber 206 such that the engagement member 262 is removably retained within the chamber 206.

The second end 260 of the tether 256 is connected the attachment member 236 in a similar manner by inserting a portion of the tether 256 into the slot 250 such that the tether 256 extends through the apertures 46 and 248. The engagement member 264 is then pressed through the aperture 248 into the chamber 244 of the attachment member 236. The engagement member 264 is thereby snap fit into the chamber 244 and is removably retained within the chamber 244. The attachment members 196 and 236, and the connector member 254 comprise a connector mechanism 268 that movably connects the cover 174 to the base 172.

As shown in FIGS. 12-14, the base 172 of the container 170 is located within the cavity 44 of the housing 42 and is supported above the floor 54 of the housing 42 by the walk of the housing 42. The cover 174 of the container 170 is located in a closed position with the cover 174 being supported by the holder 30 spaced apart from and above the base 172. A chamber 270 is located between the base 172 and cover 174 that is adapted to receive loose brewing substance. In FIG. 12, the attachment member 236 of the cover 174 is shown to be generally vertically aligned with the attachment member 196 of the base 172 when the cover 174 is in the closed position. However, the cover 174 may be rotated about its axis 222 in a clockwise or counterclockwise direction with respect to the base 172 while in the closed position to the extent that the length of the tether 256 will allow.

The cover 174 may be moved from the closed position to the open position by manually lifting the cover 174 vertically in a generally linear translational direction to an open position as shown in FIGS. 13 and 14 such that the cover 174 is spaced apart from the holder 30. The cover 174 may then be rotated clockwise or counter-clockwise generally about the axis 242 of the attachment member 236 and may alternatively or additionally be rotated about a horizontal axis extending through the axis 242. The flexible tether 256 allows the cover 174 to be moved in any desired direction with respect to the base 172. Substantial access may thereby be provided to the chamber 270 when the cover 174 is in the open position. A user may then easily place without obstruction a desired amount of a desired type of brewing substance onto the support member 186 of the base 172. Alternative, if desired, a pod of brewing substance may be placed onto the support member 186.

The cover 174 may then be moved to the closed position wherein the brewing substance is contained within the chamber 270. The holder 30 is then replaced in the mounting portion 32 of the brewer 20 for brewing a beverage in the same manner as with the container 60. After completion of a brewing cycle, the user removes the holder 30 from the mounting portion 32. The cover 174 is then moved to an open position. The moist brewing substance retained on the support member 186 of the base 172 can then be dislodged for disposal. The holder 30 and container 170, including the base 172 and cover 174, may be easily rinsed and cleaned manually or in a dishwashing machine. The container 170 may then be replaced in the cavity 44 of the holder 30 for subsequent use. If desired, the container 170 may be removed from the holder 30 for separate rinsing and cleaning.

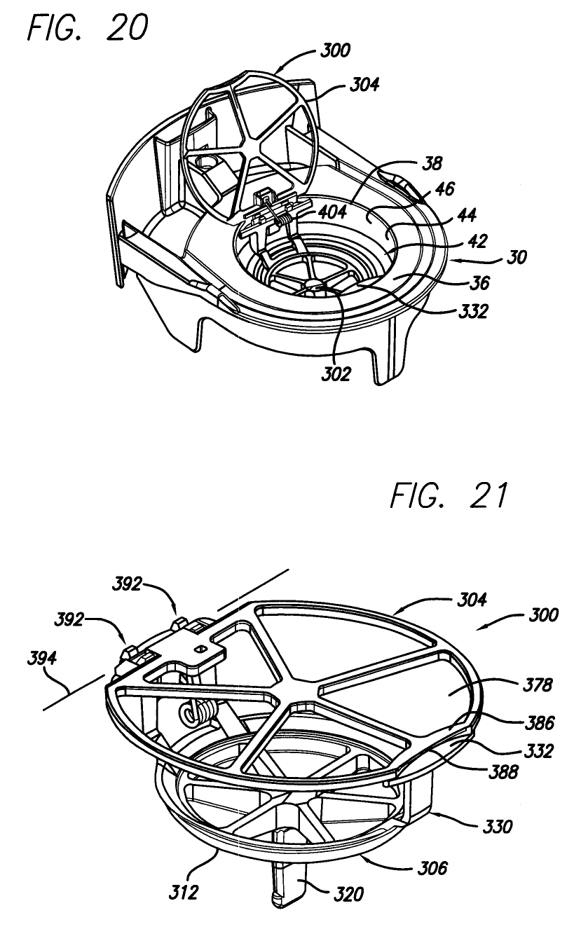

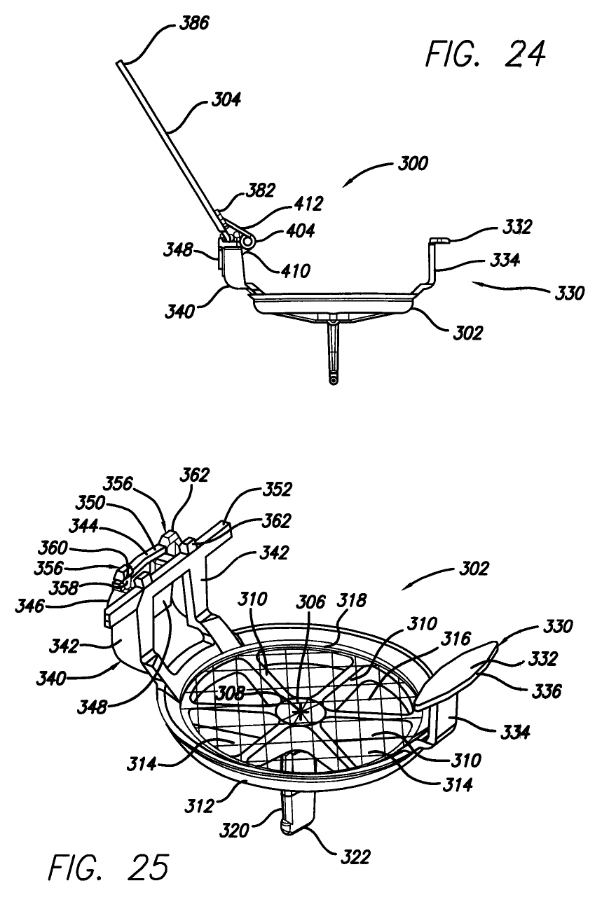

A further embodiment of the contained loose brewing substance container is shown in FIGS. 19-27 and is identified with the reference number 300. The container 300 includes a base 302 and a cover 304 that is movably connected to the base 302. The cover 304 is selectively movable with respect to the base 302 between a closed operational position aid an open position. As shown in FIG. 19, the container 300 is positioned within the cavity 44 of the housing 42 with the cover 304 located in the closed operational position. As shown in FIG. 20, the base 302 of the container 300 is located within the cavity 44 of the housing 42 of the holder 30 and the cover 304 is located outside of the cavity 44 in open position.

As shown in FIG. 25, the base 302 includes a generally central huh 306 having a central generally vertical axis 308. One or more arms 310 extend generally radially outwardly from the hub 306 and axis 308 to a generally circular rim 312. An opening 314 is located between each adjacent pair of arms 310. As shown in FIG. 25 a liquid permeable support member 316 is located on the top of the hub 306 and arms 310 and covers an area formed within an inner edge 318 of the rim 312. The support member 316 is not shown in FIG. 19-21 or 23 to provide a clear view of the remaining elements of the base 302. The support member 316 covers all of the openings 314. If desired, a plurality of support members may be used with each support member covering a respective opening 314 or a plurality of openings. The support member 316 may be formed from a foraminous material and may include a plurality of apertures or passageways and may be constructed in various different manners and with different materials, including the same manners and materials in which the support member 76 is constructed. The base 302 also includes a blade 320 having a bottom end 322. The hub 306, aims 310, rim 312, support member 316, and blade 320 may be constructed substantially identical to the corresponding components of the base 62.

The base 302 includes a stop member 330 attached to and extending generally upwardly from the rim 312. The stop member 330 includes a generally horizontal platform 332 and a leg 334 having a first end attached to the platform 332 and a second end attached to the rim 312. A lower portion of the leg 334 is adapted to conform to the configuration of the walls of the housing 42. An upper portion of the leg 334 extends generally vertically and is adapted to be spaced apart from the side wall 46 of the housing 42. As show in FIG. 25, the platform 332 includes a curved outer edge 336 that is adapted to matingly engage the curved side wall 46 of the housing 42. The top surface of the platform 332 is adapted to be located below the upper surface of the top wall 36 when the container 300 is located within the cavity 44 of the holder 30.

The base 302 includes a bracket 340 attached to the rim 312 generally diametrically across from the stop member 330. The bracket 340 includes a pair of spaced apart legs 342, each having a first end attached to the rim 312 and a second end attached to a generally horizontal mounting member 144. As shown in FIG. 25, the mounting member 344 includes a curved outer edge 346 adapted to matingly engage the curved side wall 46 of the housing 42. The mounting member 344 includes a tongue 348 that extends downwardly between the legs 342. The mounting member 344 includes a generally horizontal top surface 350 and an elongate wall 352 that extends upwardly from the top surface 350.

Two spaced apart attachment members 356 are connected to the top of the mounting member 344. Each attachment member 356 comprises a bearing member including a generally cylindrical horizontal bore 358 and a slot 360 in communication with the bore 358. The diameter of the bore 358 is greater than the width of the slot 360. The bore 358 and slot 360 form a pair of opposing resilient fingers 362. As shown in FIG. 25, the attachment members 356 are located horizontally outwardly beyond the rim 312.

The outer surface of the rim 312 of the base 302 is adapted to matingly engage and be supported by the walls of the housing 42 in the same manner as the base 62. The blade 320 is adapted to extend through the passageway 56. While the base 302 is selectively removable from the housing 42 of the holder 30, the base 302 may be permanently attached to and/or integrally formed with the holder 30.

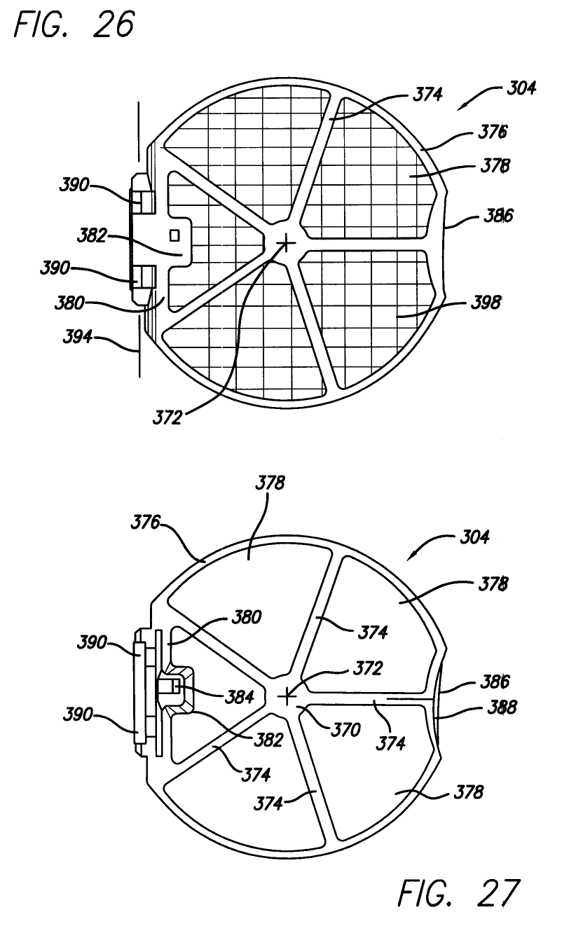

As shown in FIGS. 26-27, the cover 304 includes a central hub 370 having a central generally vertical axis 372. One or more arms 374 extend generally radially outwardly from the hub 370 to a generally circular rim 376. An opening 378 is located between each adjacent pair of arms 374. The rim 376 includes a generally linearly extending mounting member 380. A tab 382 extends inwardly into an opening 378 from the mounting member 380. The tab 382 includes a pocket 384. The rim 376 also includes an edge portion 386, that may be generally linear or that may be generally concavely curved, located diametrically across from the mounting member 380. The edge portion 386 includes an undercut forming an outwardly extending lip 388.

A pair of attachment members 390 are attached to the mounting member 380. Each cover attachment member 390 comprises a generally cylindrical shaft or journal. Each cover attachment member 390 is adapted to be removably received and retained in the bore 358 of an attachment member 356 of the base 302. The cover attachment members 390 are snap fit into the bores 358 of the base attachment members 380. Each cover attachment member 390 and its associated base attachment member 356 comprise a hinged connector mechanism 392, which allows pivotal movement of the cover 304 with respect to the base 302 about a pivot axis 394 which extends centrally through the cover attachment members 390. The cover attachment members 390 may be formed as respective portions of a single shaft or journal.

A liquid permeable retainer member 398 is located adjacent the bottom surfaces of the hub 370 and arms 374. The retainer member 398 covers all of the openings 378 and extends throughout the area formed within the rim 376. If desired a plurality of retainer members may be used, with each retainer member respectively covering one or more openings 378. The retainer member 398 is a foraminous member and may include a plurality of apertures or passageways and may be constructed from the same materials and in the same manners as the retainer member 144 is constructed. The retainer member 398 is not shown in FIGS. 19-21, 23, and 27 to provide clear view of other elements of the cover 304 and base 302. The hub 370, arms 374, and retainer member 398 of the cover 304 may be constructed substantially identical to the corresponding components of the cover 64.

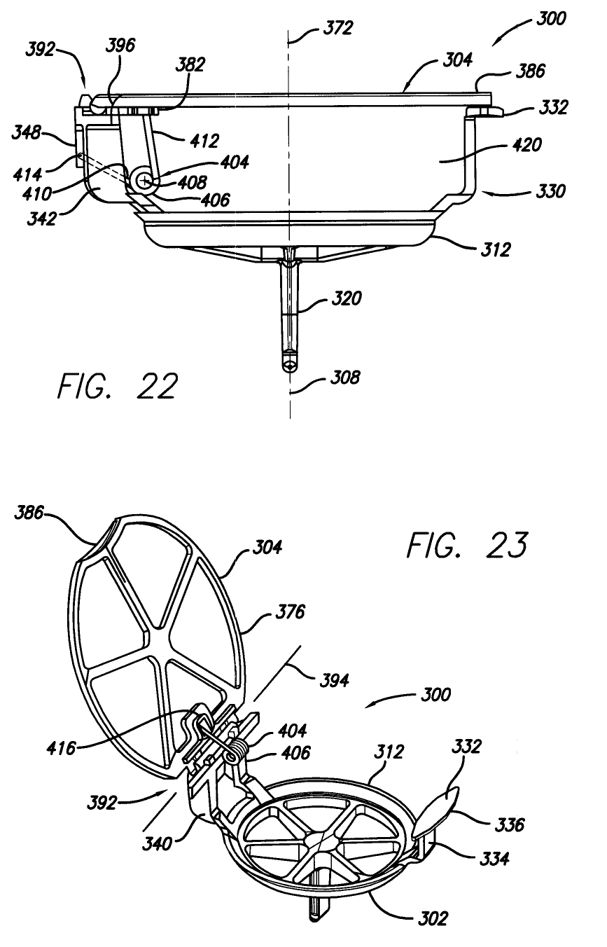

The container 300 includes a resilient biasing member 404. As shown in FIG. 22, the biasing member 404 may comprise a torsion spring having a helical coil portion 406 that extends about a central axis 408. An arm 410 extends outwardly from a first end of the helical coil portion 406 and an arm 412 extends outwardly from a second end of the helical coil portion 406. The arm 410 includes a finger 414 at its outer end that extends outwardly from the arm 410 generally parallel to the axis 408. The arm 412 includes a finger 416 at its outer end that extends generally parallel to the axis 408. The fingers 414 and 416 are resiliently moveable with respect to one another, both toward one another and away from one another, while generally pivoting about the axis 408. The helical coil portion 406 resiliently biases the fingers 414 and 416 toward an unbiased position. The biasing member 404 may be made from metal, plastic, or otter suitable materials. The biasing member 404 may be also be formed in other manners, such as a compression member or spring, or tension member or spring.

The finger 416 of the biasing member 404 is connected to the cover 304 by insertion into the pocket 384 of the tab 382. The finger 414 is connected to the tongue 348 of the bracket 340 on the base 302. The biasing member 404 is an over-center biasing member. The biasing member 404 resiliently biases the edge portion 386 of the cover 304 in a clockwise direction into engagement with the platform 332 of the stop member 330 of the base 302 when the cover 304 is in the closed position as shown in FIGS. 21 and 22

The cover 304 may be pivoted from the closed position to an open position wherein the edge portion 386 of the cover 304 is spaced apart from the stop member 330 of the base 302, such as for example as shown in FIGS. 20 and 23-24, by manually engaging the lip 388 and lifting the edge portion 386 upwardly thereby pivoting the cover 304 about the axis 394 with respect to the base 302, thereby overcoming the closing biasing force provided by the biasing member 404. Once the cover 304 is pivoted about the axis 394 beyond the position wherein the arms 410 and 412 of the biasing member 404 are in their over-center unbiased position, the biasing member 404 will resiliently bias the cover 304 in the counter-clockwise direction until axis 394 to a fully open position as shown in FIGS. 20, 23, and 24. The biasing member 404 will bias and pivot the cover 304 in the counter-clockwise direction until the stop surface 396 of the cover 304 engages the top of the wall 36 of the holder 30. The biasing member 404 thereby resiliently retains the cover 304 in the fully open position.

The cover 304 may be moved to the closed position from the fully open position by manually engaging the edge portion 386 of the cover 304 and pivoting the cover about the axis 394 in a clockwise direction thereby overcoming the open-direction biasing force of the biasing member 404 until the arms 410 and 412 of the biasing member 404 reach their over-center unbiased position. As the cover 304 is further closed, the biasing member 404 will apply a resilient close-direction biasing force to the cover 304 to pivot the cover 304 about the axis 394 in a clockwise direction until the edge portion 386 of the rim 376 engages the stop member 330 of the base 302.

As shown in FIGS. 19 and 20, the base 302 of the container 300 is adapted to be located within the cavity 44 of the housing 42 and supported above the floor 54 of the housing 42 by the walls of the housing 42. A chamber 420 is located between the base 302 and cover 304 that is adapted to receive loose brewing substance. When the cover 304 is in the closed position, the top of the cover 304 is substantially coplanar with the top surface of the top wall 36 or is located slightly there below so as to not to present an obstruction to the insertion or removal of the holder 30 from the mounting portion 32 of the brewer 20. The cover 304 substantially encloses the opening 38 in the top wall 36 when the cover is in the closed position. When the cover 304 is in the fully open position as shown in FIG. 20, substantial access is provided to the chamber 420 such that a user may easily add without obstruction a desired amount of a desired type of brewing substance onto the support member 316 of the base 302. Alternatively, if desired, a pod of brewing substance may be placed on the support member 316.

The cover 304 may then be moved to the closed position wherein the brewing substance is contained within the chamber 420. The holder 30 is then replaced in the mounting portion 32 of the brewer 20 for brewing a beverage in the same manner as with the container 60. After completion of a brewing cycle, the user removes the holder 30 from the mounting portion 32 of the brewer 20. The cover 304 is then moved to an open position. The moist brewing substance retained on the support member 316 if the base 302 can then be dislodged for disposal. The holder 30 and the container 300, including the base 302 and cover 304, may be easily rinsed and cleaned manually or in a dishwashing machine. The container 300 may the be replaced in the cavity 44 of the holder 30 subsequent use. If desired, the container 300 may be removed from the holder 30 for separate rinsing and cleaning.

Further details of the configuration and operation of the singe-serving brewer 20 can be found in related provisional applications entitled “Apparatus, System and Method for Infusing a Pre-Packaged Pod (Atty. Docket No. 27726-95094) filed Feb. 9, 2004 U.S. Provisional Application No. 60,543,370, “Apparatus System and Method or Retaining Beverage Brewing Substance” (Atty. Docket No. 2726-95093) filed Feb. 6, 2004 U.S. Provisional Application No. 60/542,433, and “Pod Brewer Design” (Atty. Docket No. 27726-95113) filed Feb. 10, 2004. Additional information relating to adjustable controlling the single-serving brewer 20 can be found in a related provisional application entitled “Adjustable Volume Brewer” (Atty. Docket No. 27726-95059) filed Nov. 7, 2003. U.S. Provisional Application No. 60/518,039. Additional information related to a spray head system and method for delivering water to the brewing assembly of the single-serving brewer 20 can be found in U.S. Provisional Application entitled “Water Delivery System, Method and Apparatus” (Atty. Docket No. 27726-95058) filed Nov. 7, 2003, U.S. Provisional Application No. 60/518,411, Additional information related to beverage making apparatus which uses loose coffee and related devices and methods of use can be fund in U.S. Provisional Application entitled “A Beverage Making Apparatus and Method Using a Loose Beverage Substances” Attorney Docket No. 27726-5865) filed Apr. 2, 2004, U.S. Provisional Application No. 60/560,033. Information about a pod holder with a removable insert can be found in U.S. Provisional Application entitled “Pod Holder with Removable Insert” (Attorney Docket No. 27726-96741) filed May 28, 2004, U.S. Provisional Application No. 60/575,235. Information about a beverage making apparatus which uses loose coffee and related devices and methods of use can be found in U.S. Provisional Application entitled “A Beverage Making Apparatus and Method Using Loose Beverage Substance” (Attorney Docket No. 27726-97275) filed Sep. 1, 2004, U.S. Provisional Application No. 60/606,233, and U.S. application Ser. No. 11/101,321 entitled “Loose Coffee Apparatus System and Method” (Attorney Docket No. 27726-98326) filed Apr. 7, 2005. Each of the above-referenced applications and the materials set forth therein is incorporated herein by reference in its entirety.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as illustrations of embodiments of the disclosure, and are not intended to be construed as containing or implying limitation the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure.

1. A reusable beverage substance container for use with a beverage maker to retain, a beverage making substance therein, the reusable container comprising:
a container portion;
a base coupled to the container portion, at least a portion of the base being foraminous; and
a cover displaceably retained on the container for allowing a beverage making substance to be placed in the container and retained therein, at least a portion of the cover being foraminous.

2. The reusable beverage container of claim 1, further comprising: a tether connected at a first end to the container portion and connected at a second end to the cover.

3. The reusable beverage container of claim 1, further comprising: a hinge connected at a first end to the container portion and connected at a second end to the cover.

4. The reusable beverage container of claim 3, wherein the hinge is a mechanical hinge.

5. The reusable beverage container of claim 3 wherein the hinge is a living hinge.

6. The reusable beverage container of claim 1, further comprising a rotary connection between the container portion and the cover.

7. The reusable beverage container of claim 1, further comprising at least a portion of the container portion and the base being sized and dimensioned for use with a brewing substance holder of a beverage apparatus.

8. The reusable beverage container of claim 1, further comprising at least a portion of the cover having at least one opening therein and a mesh material being disposed proximate to the opening to allow liquid to pass through the mesh and into the beverage making substance.

9. The reusable beverage container of claim 1, further comprising at least a portion of the base having at least one opening therein and a mesh material being disposed proximate to the opening to retain beverage making substance in the container and allow liquid to pass through the mesh.

10. The reusable beverage container of claim 1, further comprising a retainer at least a portion of the base having at least one opening therein and a mesh material being disposed proximate to the opening to retain beverage making substance in the container and allow liquid to pass through the mesh.

11. A kit for use with a beverage maker for containing a beverage making substance, the kit comprising:
a container portion;
a base coupled to the container portion, at least a portion of the base being foraminous; and
a cover displaceably retained on the container for allowing a beverage making substance to be placed in the container and retained therein, at least a portion of the cover being foraminous.

12. A kit for use with a beverage maker for containing a beverage making substance, the kit comprising:
a cover displaceably retained on a holder of the beverage maker, the holder defining a cavity for retaining beverage making substance and the cover being displaceably positionable over the cavity for selectively retaining beverage substance in the holder.

13. The kit of claim 12, further comprising: a tether connected at a first end to the container portion and connected at a second end to the cover.

14. The kit of claim 12, further comprising:
a hinge connected at a first end to the container portion and connected at a second end to the cover.

15. The kit of claim 14, wherein the hinge is a mechanical hinge.

16. The kit of claim 14, wherein the hinge is a living hinge.

17. The kit of claim 12, further comprising a rotary connection between the container portion and the cover.

18. The kit of claim 12, further comprising at least a portion of the container portion and the base being sized and dimensioned for use with a brewing substance holder of a beverage apparatus.

19. The kit of claim 12, further comprising at least a portion of the cover having at least one opening therein and a mesh material being disposed proximate to the opening to allow liquid to pass through the mesh and into the beverage making substance.

20. The kit of claim 12, further comprising at least a portion of the base having at least one opening therein and a mesh material being disposed proximate to the opening to retain beverage making substance In the container and allow liquid to pass through the mesh.

21. The kit of claim 12, further comprising a retainer at least a portion of the base having at least one opening therein and a mesh material being, disposed proximate to the opening to retain beverage making substance in the container and allow liquid to pass through the mesh.

22-25. (canceled)

26. A method of making a beverage using a reusable beverage substance container, the method comprising;
providing a reusable beverage substance container;
providing the substance container sized and dimensioned for use with a brewing
substance holder of a beverage apparatus;
placing the beverage substance container in the holder;
dispensing water from the apparatus to the holder;
passing water through the beverage substance container, beverage substance retained therein, and through the holder; and
dispensing beverage from the holder.
